(19) United States
(12) Patent Application Publication
(10) Pub. No.: US 2013/0189506 A1
(43) Pub. Date: Jul. 25, 2013

(54) MASONRY WALL VENT

(71) Applicant: James R. Keene, Mayfield Heights, OH (US)

(72) Inventor: James R. Keene, Mayfield Heights, OH (US)

(21) Appl. No.: 13/692,180

(22) Filed: Dec. 3, 2012

Related U.S. Application Data
(60) Provisional application No. 61/590,468, filed on Jan. 25, 2012.

(51) Int. Cl. E04B 2/02; B32B 5/26; B32B 7/02

(52) U.S. Cl. CPC E04B 2/02; B32B 7/02; B32B 5/26
USPC 428/213; 52/745.1; 156/60; 442/50

(57) ABSTRACT

An insert for masonry walls comprising a first layer of a high loft material and a second layer of an entangled net material, where the first layer includes dimensions of a first length, a first width, and a first thickness, where the second layer includes dimensions of a second length, a second width, and a second thickness, where the first thickness is less than the first length and first width, where the second thickness is less than the second length and the second width, and where the first thickness is not greater than the second thickness.

### CROSS REFERENCE TO RELATED APPLICATIONS

This application claims the benefit of U.S. Provisional Patent Application Ser. No. 61/590,468, filed Jan. 25, 2012, entitled “MASONRY WALL VENT,” the disclosure of which is incorporated herein by reference.

### FIELD OF THE INVENTION

The present disclosure is directed to fabrication, methods and devices used to fabricate masonry walls and in conjunction with masonry walls and, more specifically, to masonry wall vents.

### RELATED ART

The present disclosure is directed to fabrication methods and devices used to fabricate masonry walls and in conjunction with masonry walls and, more specifically, to masonry wall vents.

In the art of fabricating a masonry wall, it is known to create a void space behind the wall and in between an inner wall to allow for continuous ventilation and drainage. But when the created void space is one inch or less in depth, mortar droppings from fabrication of the masonry wall accumulate in the grout line and bridge the void space between the inner and outer walls. This creates what is called a mortar dams horizontally in the wall. When the void space is greater than one inch in depth, the mortar drippings are not wedged between the balls, but rather fall to the bottom of the void space and accumulate at the bottom of the void space. This potentially blocks the weep vents that allow for air movement in between the walls. Accordingly, there is a need in the art to inhibit mortar from blocking the void space, while maintaining air flow in the void space.

### INTRODUCTION TO THE INVENTION

The present disclosure is directed to fabrication methods and devices used to fabricate masonry walls and in conjunction with masonry walls and, more specifically, to masonry wall vents. In exemplary form, the present disclosure provides a method of enhancing air movement in a gap between adjacent walls, with one of the walls being a masonry wall, while simultaneously reducing mortar from entering this gap between the walls by providing a combination masonry vent and blocking device. This combination device comprises a laminate of a “high loft” product and an “entangled net” product. The resulting masonry blocking device may have a thickness between 5% to 40% high loft and 95% to 60% entangled net. The void space of the combination device is enhanced substantially while the face density is enhanced to prevent mortar intrusion.

Another aspect of the wall is its inconsistency. Since brick dimensions vary and interior materials vary, the width of a cavity can have areas where the designed dimension differs more than 0.25″ from the standard. This difference can be most apparent in the bottom or the top of the cavity—common areas where the more prevention or collection device is placed. Collection devices that are made from solely entangled net material can he too rigid and can create a wall that is not plumb doe to factors outside the control of the installer. A device with a high level of compressibility in the width dimension would be a great enhancement. This would be especially true if the compressible portion was a material that greatly allowed for free ventilation.

Additionally, the high loft product is greatly compressible. Another part of this combination device is its ability to compress to fill gaps having a non-uniform thickness. The high loft product is able to compress 95% under the point load of a placed brick. That means the combination device, when placed in the gap between two walls, can be compressed anywhere from 4% to 32%. The open area of the high loft fabric is such that it can mimic the quantity of air now that the entangled net material provides while greatly modifying the compression resistance with the entangled net material having substantially greater compression resistance the the highly compressible high loft fabric. This is accomplished while maintaining a similar ability to vent the cavity.

### BRIEF DESCRIPTION OF THE DRAWINGS

FIG. 1 is a cross-sectional view of an exemplary wall system in accordance with the instant disclosure.

FIG. 2 is a cross-sectional view of an exemplary laminate layer in accordance with the instant disclosure.

### DETAILED DESCRIPTION

It should be understood that the following detailed description of embodiments of the present invention are exemplary in nature and are not intended to constitute limitations upon the present invention. It is also to be understood that variations of the exemplary embodiments contemplated by one of ordinary skill in the art shall concurrently fall within the scope and spirit of the invention.

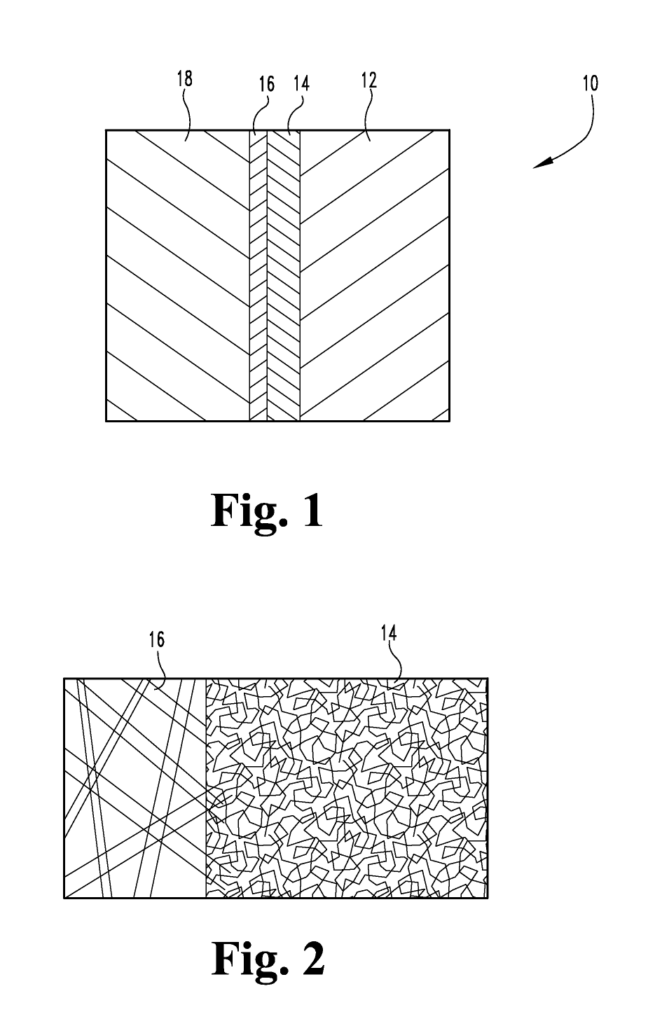

Referencing FIGS. 1 and 2, an exemplary wall system 10 comprises a series of layers. In exemplary form, a first layer comprises an inner wall 12 that may be fabricated from wood, drywall, concrete, or other various materials. Adjacent the inner wall 12 is an entangled net layer 14, which is adjacent a high loft layer 16. As used herein, high loft refers to a three dimensional, non-woven material that contains more air than fiber. This high loft layer 16 is adjacent the outer wall 18. Additional layers such as, without limitation, flashings, air barriers, and insulation may be included in between the inner and outer walls 12, 18.

As more completely described in U.S. Pat. No. 7,096,630, the entangled net layer 14 includes a plurality of intertwined filaments that twist and turn about at random and are bonded at random into sections or contact zones as by heat bonding or other suitable bonding or connection technique. These filaments maybe of any suitable strong and mildew-resistant polyethylene-type material, olefin or polymer. These are formed in a desired thickness such as on the order of about ¼″ to about ¾″ to provide the desired breathability and venting capability for water vapor, air and other gaseous substances.

The high loft layer 16 that is adjacent the entangled net layer 16 comprises a non-woven fabric bonded together with an adhesive agent. The non-woven fabric comprises strands of chopped fiber that form a three dimensional matrix. Examples of commercially available high loft material include, without limitation, Vita Non-wovens 035 and 050, Multi-Web Technologies in Brampton Ontario Canada 0.25″. Typically this high loft layer is between approximately 50% and 75% void, hut most commonly 65% void.

In exemplary form, the entangled net layer 14 and high loft layer 16 are laminated together in order to enhance air movement and simultaneously retard mortar from entering in between the walls 12, 18. In this exemplary embodiment, a heat process melts a polymer at the surface allowing for a mechanical bond between the layers 14, 16. But in lieu of a heat process, an aerosol adhesive such as Super 77 from 3M may be used to create a chemical bond between the layers 14, 16. Exemplary adhesives for this purpose include, without limitation, Bostik Hot Melt Adhesive or HB Fuller, 3M Jet Melt. The resulting laminated combination layer 14,16 is generally between 12.5% to 35% high loft and 87.5% to 65% entangled net.

Additionally, the high loft layer 16 is greatly compressible. As a result, deviations in distance between the walls 12, 18 may be accounted for more readily by having the high loft layer 16 compress when the distance is less than one inch and stay in an expanded state when, the distance is greater than one inch between the walls. By way of example, the high loft layer 16 may compress 80% or more under the point load of a placed brick.

By way of example, the thicknesses of the high loft layer 16 and the entangled net layer 14 may be customised to match the intended distance between the inner and outer walls 12, 18. More specifically, the laminated combination layer 14, 16 comprises 75% entangled net and 25% high loft layer. For a one inch intended gap between the walls 12, 18, this would include a laminated combination layer 14, 16 comprising 0.75 inches thick entangled net layer 14 and 0.25 inches thick high loft layer 16. Even if the resulting gap is less than one inch, the high loft layer 16 is able to contract to account for minor variances. However, in general, the laminated combination layer 14, 16 may comprise a thickness of between, approximately 40% to 5% high loft layer and between approximately 95% to 60% entangled net layer.

The properties of the entangled net layer 14 ensure proper airflow between the walls 12, 18, while the high loft layer 16 is operative to retard mortar from significantly pushing into the entangled net layer, thereby significantly reducing airflow between the walls.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention as defined by the following proposed points of novelty. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. An insert for masonry walls comprising a first layer of a high loft material and a second layer of an entangled net material, where the first layer includes dimensions of a first length, a first width, and a first thickness, where the second layer includes substantially similar dimensions of a second length, a second width, and a second thickness, where the first thickness is less than the first length and first width, where the second thickness is less than the second length and the second width, and where the first thickness is not greater than the second thickness.

2. The insert for masonry walls of claim 1, wherein:
the first thickness comprises between five to forty percent of the aggregate thickness of the insert; and
the second thickness comprises between ninety-five and sixty percent of the aggregate thickness of the insert.

3. The insert for masonry walls of claim 1, wherein the first layer is laminated to the second layer.

4. The insert tor masonry wails of claim 1, wherein the second thickness is between ¼ inch to ¾ inch.

5. The insert for masonry walls of claim 1, further comprising an adhesive layer interposing the first layer and the second layer.

6. The insert for masonry wails of claim 1, further comprising a. polymer layer interposing the first layer and the second layer.

7. The insert for masonry walls of claim 1, wherein the second thickness greater than two times the first thickness.

8. The insert for masonry walls of claim 1, wherein the second thickness is no less than three times the first thickness,

9. A method of fabricating a masonry wail insert, the method comprising laminating a layer of high loft material to a layer of entangled net material, where the layer of high loft material is no thicker than the layer of entangled net material.

10. The method of claim 9, wherein the step of laminating includes at least one of interposing the layer of high loft material and the layer of entangled net with a polymer layer, and applying an adhesive to an interface between the layer of high loft material and the layer of entangled net.

11. A wall system comprising:
an inner wall;
an outer masonry wall;
a layer of high loft material; and
a layer of entangled net material;
wherein the layer of high loft material and the layer of entangled net material interpose the inner wall and the outer masonry wall.

12. The wall system of claim 11, wherein the layer of high loft material and the layer of entangled net material are bonded to one another,

13. The wall system, of claim 12, wherein:
the inner wall is adjacent to the layer of entangled net material: and,
the high loft material is adjacent to the outer masonry wall.

14. The wall system of claim 13, wherein the layer of high loft material is laminated to the layer of entangled net material.

15. A method of fabricating & wall system, the method comprising;
(a) fabricating an inner wall;
(b) fabricating an color masonry wall in parallel to the inner wall; and,
(c) positioning a venting material adjacent the inner wall.

16. The method of claim 15, wherein the venting material occupies a gap extending between fee inner wall and the outer masonry wall.

17. The method of claim 16, wherein:
the gap includes a thickness dimension that is perpendicular to the length and height of the inner wall and outer masonry wall; and,
the venting material completely occupies the thickness dimension of the gap.

18. The method of claim 15, wherein:
the step of fabricating the inner wail occurs prior to the step of positioning the venting material;
the step of positioning the venting material occurs prior to the step of fabricating the outer masonry wall; and,
the step of fabricating the outer masonry wall includes fabricating the outer masonry wall adjacent to the venting material.

19. The insert for masonry walls of claim 1, wherein insert is in the shape of a repeating dove-tail contour.

20. The insert for masonry walls of claim 1, wherein insert is shaped to include a plurality of overhangs.
